(19) United States
(12) Patent Application Publication
(10) Pub. No.: US 2022/0044149 A1
(43) Pub. Date: Feb. 10, 2022

(54) TECHNIQUES FOR GENERATING MACHINE LEARNING TRAINED MODELS

(71) Applicant: Mobileye Vision Technologies Ltd., Jersulem (IL)

(72) Inventors: Chaim Rand, Modiin (IL); Aaron Siegel, Jerusalem (IL); Amit Weizner, Kiryat Motzkin (IL)

(21) Appl. No.: 17/391,291

(22) Filed: Aug. 2, 2021

Related U.S. Application Data
(60) Provisional application No. 63/112,210, filed on Nov. 11, 2020.
(60) Provisional application No. 63/110,488, filed on Nov. 6, 2020.
(60) Provisional application No. 63/083,608, filed on Sep. 25, 2020.
(60) Provisional application No. 63/061,444, filed on Aug. 5, 2020.

(51) Int. Cl. G06N 20/00; G06K 9/00; G06N 3/08; G06K 9/62

(52) U.S. Cl. CPC G06N 20/00; G06K 9/6256; G06N 3/08; G06K 9/00791

(57) ABSTRACT

Techniques are disclosed for the implementation of machine learning model training utilities to generate models for advanced driving assistance system (ADAS), driving assistance, and/or automated vehicle (AV) systems. The techniques described herein may be implemented in conjunction with the utilization of open source and cloud-based machine learning training utilities to generate machine learning trained models. One example of such an open source solution includes TensorFlow, which is a free and open-source software library for dataflow and differentiable programming across a range of tasks. TensorFlow may be used in conjunction with many different types of machine learning utilities.

### CROSS-REFERENCE TO RELATED APPLICATIONS

This application claims priority to provisional application No. 63/061,444, filed on Aug. 5, 2020, to provisional application No. 63/083,608, filed on Sep. 25, 2020, to provisional application No. 63/110,488, filed on Nov. 6, 2020, and to provisional application No. 63/112,210, filed on Nov. 11, 2020, the contents of each of which are incorporated herein by reference in their entireties.

### TECHNICAL FIELD

Aspects described herein generally relate to training systems and, more particularly, to techniques that generate machine learning trained models.

### BACKGROUND

Driving assistant products typically use artificial intelligence (AI) technologies. For example, autonomous vehicle (AV) system developers may need to train several different types of machine learning models targeted for the next generation of Advanced Driving Assistants, Autonomous Vehicles, and Road Experience Management products (or other AV/HD maps). This involves a vast infrastructure that needs to be fast, flexible, scalable, and secure. As this infrastructure may be costly and complex, the current means by which to achieve these goals to produce these trained models has been inadequate.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 illustrates a machine learning training flow, in accordance with various aspects of the present disclosure;

FIG. 2 illustrates a machine learning training flow, in accordance with various aspects of the present disclosure; and

FIG. 3 illustrates additional details of the machine learning training flow associated with the preprocessing stage and the training and evaluation stage as shown in FIG. 2, in accordance with various aspects of the present disclosure;

The exemplary aspects of the present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the aspects of the disclosure may be practiced. In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

I. An Example Machine Learning Model Training Architecture

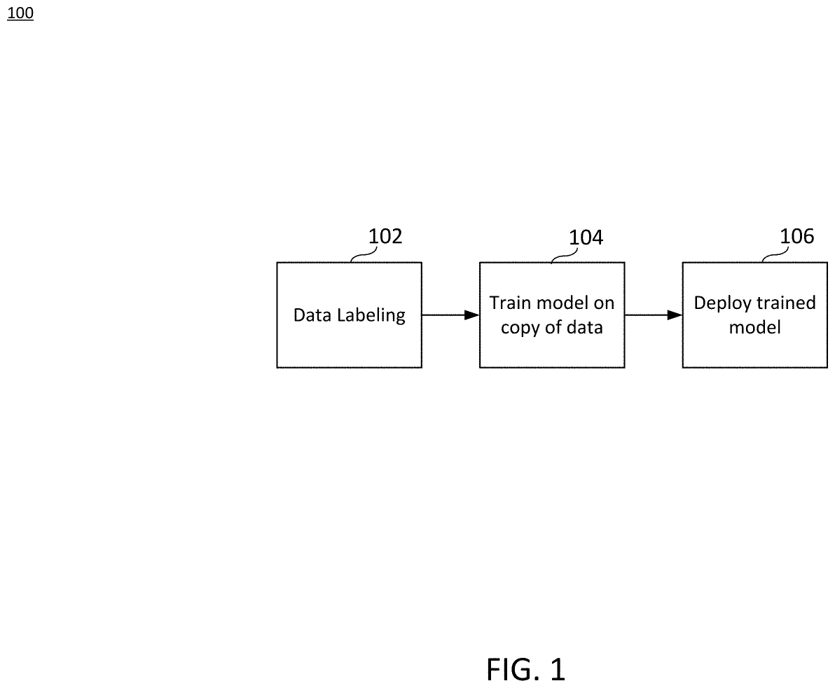

FIG. 1 shows an overview of the development cycle associated with a machine learning training process, in accordance with various aspects of the present disclosure. The machine learning training process trains a machine learning model using a set of data that is labeled in accordance with known data types for a particular application. The machine learning trained models may include, for example, a model that enables machine vision to recognize and classify objects included in a road scene, a driving model, or other suitable type of model (e.g. a safety driving model or driving policy model) which may be implemented, for example, as part of an advanced driving assistance system (ADAS), a driving assistance, and/or automated driving system (AV system). It is noted that in the field of image processing, machine vision and machine learning are sometimes used to distinguish between more “traditional” image processing technologies and machine learning-based techniques. As the term “machine vision” is used herein, this refers to any suitable type of image processing techniques, including such traditional or known techniques in addition to or instead of machine learning based techniques to facilitate the recognition and/or classification of objects included in a road scene, a driving model, or other suitable type of model, as noted above.

The development cycle 100 as shown in FIG. 1 includes a labeling stage 102, a training stage 104, and a deployment stage 106, which may represent part of or the entirety of a machine learning model training system. The amount of data used as part of the labeling stage 102 may be significant, such as 80 TB of data or more, for instance. The labeled data is then fed into a training stage 104, which generates the machine learning trained model (or simply a “trained model,” or “model”) for a particular application, which is then deployed in a particular use case (e.g. an AV) as part of the deployment stage 106. Although referred to herein as a machine learning trained model, this may not necessarily refer to a model that has been completely trained, and instead may represent the model in any part of its development or training cycle, i.e. as the model is being trained via iterations of a machine learning training loop, as further discussed herein.

As further discussed herein, ADAS and AV systems utilize object detection systems as a type of machine vision, which allows for the detection (e.g. recognition) and identification (e.g. classification) of objects in a road scene. The ADAS or AV system may use this information for various automated driving and/or navigation tasks, which may depend upon the location, environment, and type of object that is detected. For instance, the sensed data (and in some instances, map data) may be used to build an environmental model, and the environmental model may then be used by to construct a “state” that is used by the driving policy to determine an “action” that is to be carried out by the host vehicle. In other instances, the objects detected by the sensors onboard a vehicle (e.g., cameras, Radar, Lidar etc.) can be used to create or update a map of the vehicle's environment and also to localize the vehicle on a map. Therefore, it is preferable, and often necessary, for an ADAS or AV system to accurately and reliably identify the location of objects within a particular field of view corresponding to a specific road scene as well as what type of object has been detected. For instance, the road scene may correspond to a front view similar to what would be experienced by a driver driving the vehicle, or any other suitable field of view around the vehicle for which the detection of object locations and types may be useful for driving, navigation, mapping and/or localizing the vehicle on a map.

For the aspects described herein, which may implement trained machine learning models to facilitate machine vision for AV and ADAS systems, for example, the data labels may be associated with, for instance, pixels or other portions of a road scene. The labels may identify specific objects and/or object types with which the pixels of portions of the road scene are associated. Using the training data with predetermined or known labels, the model is then trained as data from the training dataset is received as part of a training loop, which generally includes the training and evaluation of training loop data to converge to a trained model that behaves in a desired way. This may include an evaluation based upon additional test images not included in the original training test data to determine the accuracy of the trained model. The machine learning trained model may then be deployed such that pixels or portions of images of a new (e.g. arbitrary) road scene, which the trained model has previously not been exposed to, may be identified. For instance, for AV or ADAS machine vision systems, the goal is to achieve a trained machine learning model that accurately recognizes and classifies different types of objects, road lines, road types, infrastructure, road geometry, road edges, road users, general objects, dynamic object, etc. in a variety of different road scenes and conditions (e.g. day time, night time, during different types of weather, different types of vehicles and objects, etc.).

II. Introduction to TensorFlow

The use of machine vision as described above, which labels data associated with pixels or other portions of a road scene, is provided by way of example and not limitation. The aspects described herein may be adapted or expanded to implement other suitable types of data for which a model is to be trained for a particular application. As an additional example, the training data may correspond to non-visual machine learning applications, such as point cloud data for a light detection and ranging (LIDAR) sensor, for instance, with labels being applied to the point cloud data in any suitable manner. As yet additional examples, the training data may include other basic elements of a two- or three-dimensional representation such as a coordinate in a range map, a voxel in a three dimensional grid, etc. Irrespective of the particular type of training data that is used, the aspects described herein may label the data using predetermined or known labels identifying portions of the training data for use with the machine learning trained model, which, once fully trained, accurately recognizes and classifies different types of data for that particular application based upon the type of training data that is used.

Therefore, for various applications such as ADAS and AV systems, machine learning is used to train such models as a fundamental part of their operation with respect to machine vision, identifying road objects, and performing specific actions based upon the recognition of those objects. However, and as noted above, such machine learning model training techniques have various drawbacks, particularly with respect to the need to use expensive and complex infrastructure and the difficulty to meet required developmental goals. Thus, current AV system developers, as well as other industries that rely upon machine learning model training techniques, have begun to utilize open source and cloud-based machine learning training utilities to generate machine learning trained models for particular applications. One example of such an open source solution includes TensorFlow, which is a free and open-source software library for dataflow and differentiable programming across a range of tasks. TensorFlow is a symbolic math library, and is also used for machine learning applications such as neural networks. TensorFlow may be used in conjunction with many different types of machine learning utilities, such as Amazon's cloud-based Sagemaker utility for instance, which is a fully-managed service that enables developers and data scientists to quickly and easily build, train, and deploy machine learning models at any scale.

Thus, although not limited to such implementations, the aspects described herein may be used to adapt a machine learning training utility, such as Amazon Sagemaker, for instance, to the training models used for specific applications such as those used by AV system developers. In the various aspects further described herein, techniques are described to adapt neural networks (e.g. deep neural networks (DNNs)) used in accordance with a machine learning training utility, which advantageously accelerates the development cycle.

The aspects herein are described in further detail herein with respect to using TensorFlow, as TensorFlow is commonly-used for machine learning training. However, such an implementation is by way of example and not limitation. It will be understood that the aspects described herein may be applied to any suitable type of machine learning system, utility, and/or application without departing from the spirit and scope of the disclosure. For instance, the aspects described herein may use TensorFlow or other suitable libraries with Sagemaker or other machine learning training utilities, which may be cloud-based or part of a locally utilized infrastructure. As additional examples, Sagemaker supports other ML libraries such as PyTorch and mxnet. Moreover, other cloud-based providers support alternatives to Sagemaker such as Google Cloud ML and Microsoft Azure Machine Learning Studio, and these may also be implemented in accordance with the aspects described herein. Thus, the aspects described herein may implement any suitable type of machine learning library system in combination with any suitable type of machine learning training utility to generate machine learning trained models.

III. An Example Machine Learning Model Training Process Flow

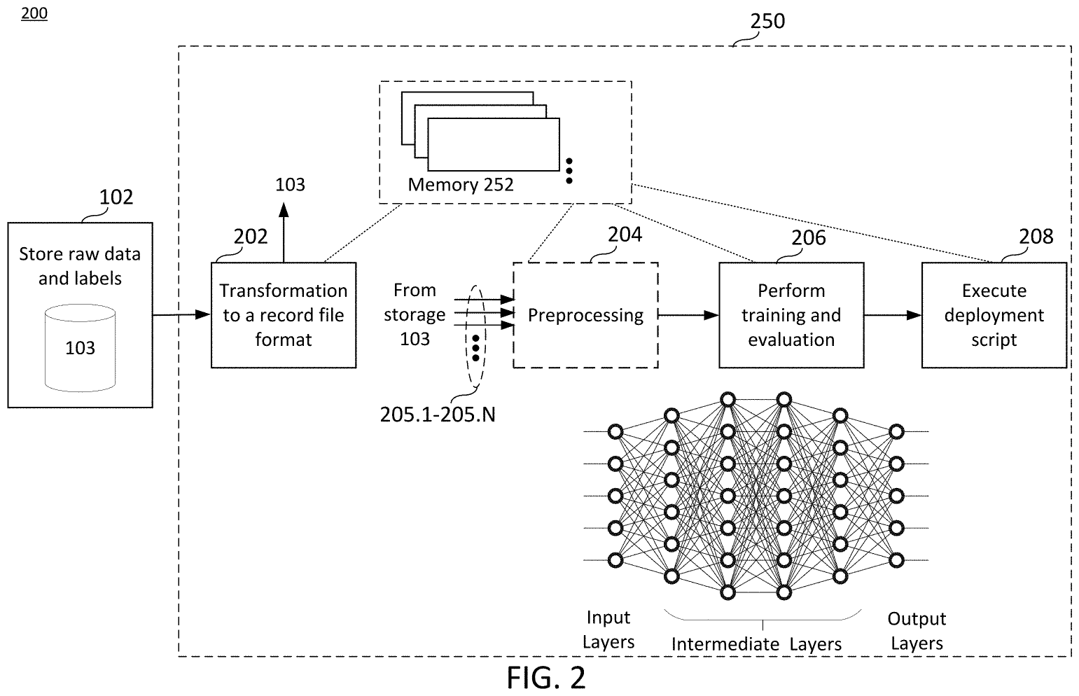

FIG. 2 illustrates an example flow for a cloud-based machine learning training utility, in accordance with various aspects of the present disclosure. Although referred to as a flow in FIG. 2, the flow 200 may be performed as part of a machine learning model training system or process that implements any suitable type of hardware in conjunction with the various software solutions described herein. For example, the flow 200 may include a processing portion 250, which implements one or more processors and/or hardware-based processing devices, hardware-based circuitry, etc. By way of example, the one or more processors included as part of the processing portion 250 may comprise one or more microprocessors, microcontrollers, pre-processors (such as an image pre-processor), graphics processing units (GPUs), a central processing unit (CPU), support circuits, digital signal processors, integrated circuits, memory, an application-specific integrated circuit (ASIC), part (or the entirety of) a field-programmable gate array (FPGA), or any other types of devices suitable for running applications, to perform data processing and analysis, to carry out instructions (e.g. stored in data storage 103, memory 252, etc.) to perform arithmetical, logical, and/or input/output (I/O) operations, and/or to control the operation of one or more components associated with the flow 200 to perform various machine learning model training functions associated with the aspects as described herein.

Any of the one or more processors implemented via the flow 200 may be configured to perform certain functions in accordance with programmed instructions, which may be stored in a local memory 252 associated with the one or more processors, data storage 103, and/or other accessible memory (not shown) as needed. In other words, a memory (e.g. data storage 103, memory 252, etc.) implemented via the flow 200 may store software or any suitable type of instructions that, when executed by a processor (e.g., by the one or more processors implemented via the processing portion 250), controls the operation of a machine learning model training process, e.g., the flow 200 as described by the functionality of the various aspects herein. A memory (e.g. data storage 103, memory 252, etc.) may store one or more databases, image processing software, etc., as well as various components of a specific type of machine learning model to be trained, such as a neural network, a deep neural network (DNN), and/or a convolutional deep neural network (CNN), and/or instantiated equivalents thereof, for example, as further discussed herein. The data storage 103 and/or memory 252 may be implemented as any suitable non-transitory computer-readable medium such as one or more random access memories, read only memories, flash memories, disk drives, optical storage, tape storage, removable storage, cloud storage, or any other suitable type of storage.

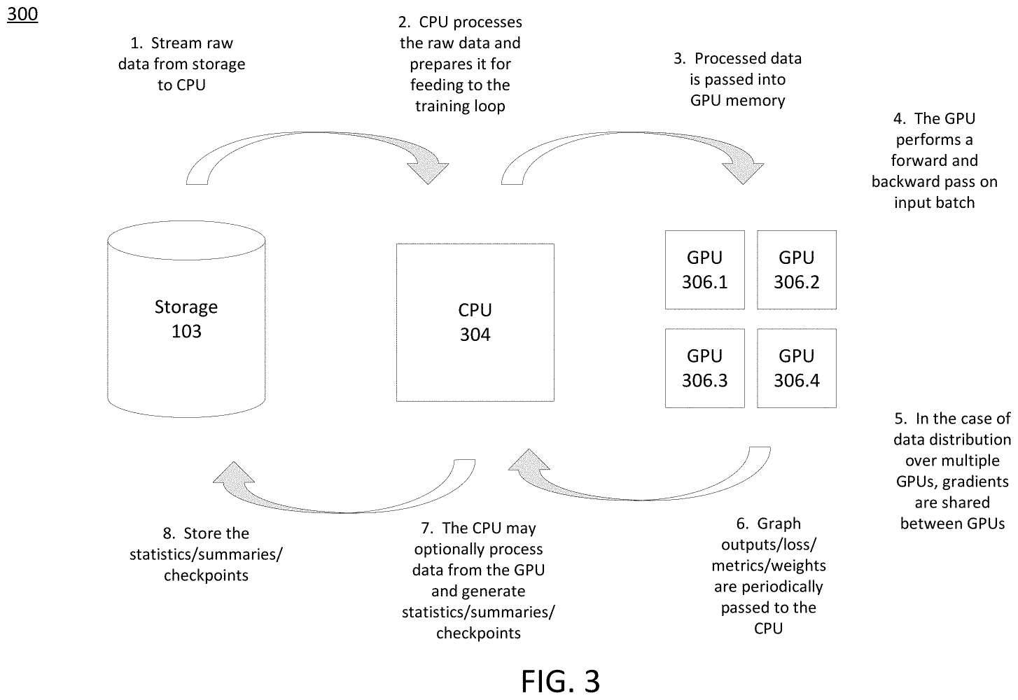

For example, processing portion 250 may implement one or more processors such as a central processing unit (CPU), which is further discussed below with reference to FIG. 3. The processing portion 250 may include any suitable type of processing device, and may be implemented based upon the particular utility of which the flow 200 forms a part. For instance, the one or more processors implemented via the processing portion 250 may form part of a cloud-based machine learning training utility (e.g. Amazon Sagemaker), a local machine learning training utility including one or more servers and/or computing devices, or combinations of these. The training and evaluation stage 206 in particular may additionally implement one or more graphics processing units (GPUs), which are utilized to perform the training loop iterations, and which may comprise forward and backward training iterations on training loop data as discussed herein and further discussed below with reference to FIG. 3. Thus, the training and evaluation stage 206 may comprise the execution, via the one or more processors identified with the processing portion 250, of the machine learning training loop as discussed herein in further detail.

The various components used to implement the flow 200 are represented in FIG. 2 as blocks interconnected with arrows. For instance, the labeling stage 102 may be identified with an implemented data storage 103 (e.g. S3, a local memory, could storage, etc.), whereas the stages 202, 204, 206, 208, etc. may be identified with processing portion 250, the implementation of one or more CPUs, GPUs, etc., and any accompanying memory 252 associated with these processing components, which function to perform part of an overall machine learning training process or algorithm represented by the flow 200. The arrows shown in FIG. 2 may thus represent respective data interfaces communicatively connecting the various stages of the flow 200 (e.g. the components implemented to provide the associated functionality). For example, a data interface may be coupled between the labeling stage 102 and the transformation stage 202 to facilitate loading data from data storage 103, which is then transformed via processing operations by one or more processors of the processing portion 250 at stage 202, as further discussed herein. The data interfaces shown in FIG. 2 may represent any suitable type and/or number of wired and/or wireless links, which may implement any suitable type and/or number of communication protocols.

In an aspect, a data stream may be implemented by any suitable number N of data streams 205.1-205.N, which may comprise any suitable number of physical links, connections, ports, etc. to facilitate a data transfer. The data streams 205.1-205.N as shown in FIG. 2 thus facilitate a transfer of data from the data storage 103 to the transformation stage 202.

The example flow 200 as shown in FIG. 2 utilizes the labeling stage 102 as shown in FIG. 1, which again may include the use of data labels associated with, for instance, pixels or other portions of a road scene, for instance, in the example above that the trained model is to be used for an ADAS or AV application, or other suitable type of training data depending upon the particular application. However, the use of Sagemaker and many other training utilities requires the transformation of the training data into one of the data formats supported by the particular data set. These formats may include, for example, TextRecords, TFRecords, and Protobuf, which is performed in the transformation stage 202. Thus, aspects include the transformation stage 202 generating, from the data received from the data storage 103, transformed record file data of a suitable format. This may include, for instance, using AWS batch service (on many parallel CPUs). This transformed record file data may then be stored in the data storage 103, and then streamed or otherwise provided (e.g. via the data streams 205.1-205.N) to a training instance in the next stages of the flow 200 as discussed in further detail below.

In an aspect, TFRecords is selected as the preferred format as shown in FIG. 2, although the aspects described herein may implement any suitable type of data formats for this purpose. Because TFRecords is TensorFlow's binary storage format, other types of data with different formats may be converted to the TFRecords format in a straightforward manner.

To modify the data creation flow, the development flow may be ported to any suitable type of training utility, which may advantageously further accelerate data creation time (from several days to a couple of hours) and thus further accelerate the overall development time. Regardless of the particular type of input mode and format that is used, aspects include ensuring that the training data is prepared accordingly, i.e. for the specific type of data format that is selected (e.g. TFRecords). Data preparation may include, for example, providing a storage prefix in accordance with the particular implementation (e.g. an S3 storage prefix). Thus, when one or more of the data streams 205.1-205.N is opened, all of the files that match the given prefix are fed one-by-one into the data stream. The size of the files may impact the performance of the data stream. For instance, file sizes that are too small or too large will slow down the training cycle. Thus, a target file size should be selected that ensures quick and efficient operation, which may be determined from experimentation with a particular data set and/or known from previous training with similar types of data. For instance, the aspects described herein may utilize a predetermined target file size of 100 megabytes or other suitable sizes. Thus, aspects include using a set of conditions for the training process, with the first being that the training data is broken down into TFRecord files of approximately (e.g. +/−5%, 10%, etc.) of a predetermined file size (e.g. 100 megabytes) each.

The data may be shuffled at one or more of the transformation stage 202, the training stage 206, and/or as part of the data streams 205.1-205.N. As noted above, the machine learning model training process is one that uses received training data to converge to a trained model that behaves in a desired way. Therefore, it is desirable to randomize, or “shuffle” the order in which the machine learning training process receives and processes the training data. Failure to do so may result in the model initially converging to recognize a specific type of data if similar images (e.g. all day time images) are first processed, and then being unable to successfully converge to recognize different image or scene types.

The training and evaluation stage 206 may utilize the pre-processed data output by the preprocessing stage 204 to generate a machine learning trained model for a particular application, which is then deployed for a particular use case (e.g. navigating an AV) as part of the deployment stage 208. The deployment script may include, for example, transferring the (now fully trained) model to a suitable component for use with a particular implementation and application. For instance, if the trained model is to be used for a machine vision application in an ADAS or AV system, then the trained model may be loaded onto an electronic control unit (ECU) of the vehicle in which the trained model is implemented. Additional details regarding the implementation of the training and evaluation stage 206 are discussed further below with reference to FIG. 3.

Again, although the aspects described herein may be applicable to any suitable type of machine learning training utility, the previous example is used for purposes of clarity and ease of explanation throughout this section. The performance of a DNN training session running in TensorFlow may be profiled for further analysis. As used herein, the term “performance” profiling of a machine learning training session may reference the analysis of the speed at which the training is performed (as measured, for example, by the training throughput or iterations per second), and the manner in which the session utilizes the system resources to achieve this speed.

The aspects further described in this Section thus enable a user to determine why the training is running slowly and how this speed may be increased. Again, the examples provided herein are written in TensorFlow and may run in the cloud using the Amazon SageMaker service, but the aspects described herein are equally applicable to any other suitable training environment. The aspects aim to maximize (or at least increase) the throughput of a training session, given a fixed training environment, without harming the quality of the resultant model or increasing the number of training samples required for convergence. For purposes of clarity and ease of explanation, the aspects described herein proceed under a few underlying assumptions.

For example, it is assumed for ease of explanation that the training is being performed on a single instance/machine and that the instance type is fixed. Of course, different models perform differently on different types of machines. In an ideal situation, a machine that is optimal for the model being trained could be chosen, that is, a machine on which all resources would be fully utilized. In this way, the cost of resources that are not being used could be avoided. However, there are usually practical restraints with respect to a fixed number of instance types to choose from. For example, Amazon SageMaker offers a wide variety of instance types (https://aws.amazon.com/sagemaker/pricing/instance-types/) to choose from that differ in the types and number of GPUs, the number of CPUs, the network properties, memory size and more. On the other hand, one does not have the ability to freely choose (based on the properties of a given model) a machine with a specific number of CPUs, a specific GPU, and specific network bandwidth.

Therefore, to choose a most appropriate training instance, one must carefully weigh how well a model is suited to different training instances versus considerations such as the cost and availability of those instances, as well as scheduling requirements. This requires a comprehensive analysis of the maximum achievable performance of training the model on each of the different instances types, as further described herein. The examples provided herein are limited to instance types with a single GPU for clarity. Specifically, the examples discussed herein are provided with respect to machines with an NVIDIA® V100 Tensor Core GPU. In the context of the Amazon SageMaker service for training, this is the ml.p3.2xlarge instance type.

There are many different libraries and frameworks available for training DNN models. The training performance of a fixed model, fixed training algorithm, and fixed hardware, will vary across different software solutions. The examples provided herein are with respect to the TensorFlow training environment. However, even within this training environment, performance may depend on a number of factors such as the framework version, whether a high level API is selected such as tf.estimator or tf.keras.model.fit, whether a custom training loop is implement, and the manner in which the training data is fed into the training pipeline. Thus, the examples provided herein are provided under the assumption that the training is performed in TensorFlow 2.2 using the tf.keras.model.fit( ) API, and that the data will be fed using the tf.dataset APIs. Again, this is but one implementation by example and not limitation, and the aspects described herein may be expanded to any suitable type of training system.

IV. An Example Machine Learning Training Flow

FIG. 3 illustrates an example of a training flow, in accordance with one or more aspects of the present disclosure. The machine learning training flow 300 as shown in FIG. 3 illustrates additional details of the machine learning training flow associated with the preprocessing stage 204 and the training and evaluation stage 206 as shown in FIG. 2, in accordance with various aspects of the present disclosure. Thus, although referred to herein as a machine learning training flow, the machine learning training flow 300 may represent any suitable portion of (or the entirety of) a machine learning model training system. As noted above with respect to FIG. 2, the training and evaluation stage 206 receives the preprocessed data, which may include the use of the data streams 205.1-205.N. The training and evaluation stage 206 incorporates the received and preprocessed data, which may be shuffled and boosted in accordance with known techniques, to generate a machine learning trained model that is deployed for a particular application, such as ADAS and AV systems, for instance. To identify and explain possible sources of bottlenecks within a training session, FIG. 3 shows an example training pipeline with the training process broken down into eight stages. Any one of these steps may potentially impede the training flow. Again, for purposes of brevity, the training process is performed in this example on multiple GPUs 306.1-306.4, and it is assumed that a single CPU 304 is implemented by way of example and not limitation.

Stage 1 as shown in FIG. 3 includes the streaming (i.e. loading) the raw data from storage (e.g. S3) to the CPU(s). This generally is the case unless the training data is automatically generated. The streaming or loading step may therefore include, for instance, loading training data from a local disk, over a suitable network location, from a remote storage location, etc. In any event, system resources are utilized in this stage that could potentially block the pipeline (e.g. the data streams 205.1-205.N as shown in FIG. 2). If the amount of raw data per training sample is particularly large, if the IO interface has high latency, or if the network bandwidth of the training instance is low, then the CPU 304 may be idle while awaiting for the raw data. An example of this is when training with Amazon SageMaker using “filemode,” in which all of the training data is downloaded to a local disk before the training even starts. If there is a significant amount of data, this idle time may introduce a large delay with respect to the waiting times.

Resource limitations are also a concern. For example, if a particular instance type supports network IO of up to 10 Gigabits per second, and each sample requires 100 Megabits of raw data, an upper limit of 100 training samples per second will be reached irrespective of the speed of the GPUs 306.1-306.4. In an aspect, such issues may be overcome by reducing the amount of raw data, compressing some of the data, or choosing an instance type with a higher network IO bandwidth. In the example discussed herein, it is assumed that a limitation is associated with the network IO bandwidth of the instance, but such limitations could also be caused by a bandwidth limitation with respect to the amount of data that may be pulled from storage (e.g. data storage 103), or from elsewhere along the line of loading data into the CPU 304.

With continued reference to FIG. 3, stage 2 in the training pipeline includes data pre-processing. This preprocessing stage may be identified, for example, with the preprocessing stage 204 as shown and described above with reference to FIG. 2. In this stage, which is performed by the CPU 304 in this example, the raw data is prepared for entry to the training loop. This might include applying augmentations to input data, inserting masking elements, batching, filtering, etc. The TensorFlow.dataset functions include built-in functionality for parallelizing the processing operations within the CPU 304 (e.g. the num_parallel_calls argument in the tf.dataset.map routine), and also for running the CPU 304 in parallel with the GPUs 306.1-306.4 (e.g. tf.dataset.prefetch). However, if running heavy, or memory intensive computation are executed at this stage, the GPUs 306.1-306.4 may remain idle awaiting data input.

Stage 3 includes the transfer of data from the CPU 304 to the GPUs 306.1-306.4. This stage is implemented because, in most cases, the CPU 304 and the GPUs 306.1-306.4 use different memory, and the training samples need to be copied from CPU memory to GPU memory before the training loop can run. This stage can therefore also potentially result in a bottleneck, depending on the size of the data samples and the interface bandwidth. Therefore, aspects include holding off on casting to a higher bit representation (tf.cast( )) or decompressing bit masks (tf.one_hot) until after the data is copied to GPU memory (e.g. of the GPUs 306.1-306.4).

Stage 4 includes the GPU forward and backward training pipeline, which constitutes the heart of the training pipeline of the training flow 300 and the core of the machine learning training loop as discussed herein. This stage is performed via the GPUs 306.1-306.4 and, because the GPUs 306.1-306.4 are the most expensive resource, it is preferred to have the GPSs 306.1-306.4 as active as possible (i.e. constantly or close to constantly) and run at peak performance. In most cases, the average throughput, in number of samples trained per second, increases as the batch size is increased, so aspects include increasing the batch size to match the memory capacity of the GPUs 306.1-306.4 or within a threshold of matching the GPUs memory capacity (e.g. 99%, 95%, 90%, etc.).

The throughput of stage 4 is a function of the model architecture and loss function. In various aspects, techniques for reducing the computation include a preference of cony layers over dense layers, replacing large convolutions with a series of smaller ones with the same receptive field, using low precision or mixed precision variable types, consideration of using TensorFlow native functions instead tf.py_func, preference of tf.where over tf.cond, researching how a model and layer settings, such as memory layout (channels first or last), and memory alignment (layer input and output size, number of channels, shapes of convolutional filters, etc.) impact GPU performance and design the model accordingly, and a customization of the graph optimization (See https://www.TensorFlow.org/guide/graph_optimization).

Stage 5 is optional, and may be performed when distributed training is executed on multiple GPUs, either on a single training instance or on multiple instances. When present, this stage can also potentially introduce a bottleneck. For instance, during distributed training, each GPU 306.1-306.4 collects the gradients from all other GPUs. Depending on the distribution strategy, the number and size of the gradients, and the bandwidth of the communication channel between GPUs 306.1-306.4, a GPU may also be idle while collecting the gradient data. To solve such issues, the bit precision of the gradients may be reduced and/or the communication channel tuned, or other distribution strategies may be implemented.

Stage 6 includes the transfer of data from the GPUs 306.1-306.4 to the CPU 304. That is, during training, the GPUs 306.1-306.4 will return data to the CPU 304. Typically, this includes the loss and metric results, but may periodically also include more memory-intensive output tensors or model weights. As before, this data transfer can potentially introduce a bottleneck at certain phases of the training, depending on the size of the data and the interface bandwidth.

Stage 7 includes model output processing. In this stage, the CPU 304 may, for instance, perform processing on the output data received from the GPUs 306.1-306.4. This processing typically occurs within TensorFlow callbacks (see https://www.TensorFlow.org/api_docs/python/tf/keras/callbacks/Callback). These can be used to evaluate tensors, create image summaries, collect statistics, update the learning rate and more. There are different ways in which this may reduce the training throughput. First, if the processing is computation- or memory-intensive, this may become a performance bottleneck. If the processing is independent of the model GPU state, it is preferable to try running in a separate (non-blocking) thread. Second, running a large number of callbacks could also bottleneck the pipeline. One consideration is to combine the callbacks into a smaller number. Third, if the callbacks are processing output on each iteration, it is likely to be slowing down the throughput. In such a case, consideration should be given to reducing the frequency of the processing, or adding the processing to the GPU model graph (e.g. using custom TensorFlow metrics (See https://www.TensorFlow.org/api_docs/python/tf/keras/metrics/Metric).

Stage 8 includes the CPU 304 to data storage 103 transfer. For instance, during the training the CPU 304 may periodically transfer event files, log files, or model checkpoints to storage. Again, a large quantity of data combined with a limited IO bandwidth could potentially lead to latency in the training pipeline. And, even if care is taken to make the data transfer non-blocking (e.g. using dedicated CPU threads), network input and output channels may be used that share the same limited bandwidth. In this case, the amount of raw training data being fed on the network input could drop. One way this could happen is if all of TensorFlow summaries are collected in a single event file, which grows and grows during the course of the training. Then, each time the event file is uploaded to storage (e.g. data storage 103), the amount of data passing on the network increases. When the file becomes very large, the data upload can interfere with the training.

V. Using Custom Loss Functions

With reference to the machine learning training flow 300 as shown in FIG. 3, the data storage 103 stores labeled training data that is received and processed by the CPU 304 as part of a preprocessing stage. This preprocessing of the labeled training data may generate data that is processed by the GPUs 306.1-306.4 in accordance with any suitable number of iterations that may be alternatively be referred to herein as a machine learning training loop, which may constitute the forward and backward passes on input batches as discussed herein. As used herein, the data that is processed as part of the machine learning training loop may be alternatively referred to herein as training loop data, and may include any suitable type of data that is analyzed in accordance with the machine learning training loop such as the data provided by the preprocessing stage 204, data features, labels, weights, gradients, or any other suitable type of data that is passed between the various layers of the machine learning trained model as shown in FIG. 2 for example. Again, the machine learning trained model that is generated in this manner may be implemented, for example, to enable machine vision to recognize and classify objects included in a road scene, as discussed herein.

To do so, the machine learning training flow 300 as shown in FIG. 3 may implement any suitable type of machine learning algorithms, which may include for instance the aforementioned open source and cloud-based machine learning training utility known as Tensorflow. It should be noted that the move from TensorFlow 1 to TensorFlow 2 introduces a considerable number of changes (see for example https://www.tensorflow.org/guide/migrate). One of the most significant changes is that TensorFlow 2 promotes the tf.keras API over the tf.estimator API, which was the prominent high level API in many of the TensorFlow 1 releases. To make matters more complicated, the restrictions imposed by the tf.keras APIs appears to be greater than the restrictions imposed by the tf.estimator APIs.

Moreover, for clarity it is noted that in TensorFlow 2.2, an intermediate level of customization is introduced via the tf.keras.model train_step (https://www.tensorflow.org/apidocs/python/tf/keras/Model#train_step) and test_step (https://www.tensorflow.org/api_docs/python/tf/keras/Model#test_step) functions. This enables one to take advantage of the optimizations offered by the high level fit( ) routine while also inserting customization, which may be an appropriate option for some users. The benefits of the high level APIs used in this developmental example is described in the Keras (non tf) documentation here (https://keras.io/guides/customizing_what_happens in_fiti).

Regardless of the particular machine learning training algorithm that is implemented for this purpose, various aspects of the machine learning training loop may be customized depending upon the particular application requirements, with some of these customizations being previously noted. In the aspects described herein, it is assumed that TensorFlow 2 and the keras APIs are implemented to take advantage of the most up-to-date optimizations and capabilities, with considerations given to the deployment process (DLO) requiring tf.keras. However, this is by way of example and not limitation, and the aspects as described herein may be implemented in accordance with any suitable type of machine learning training techniques, Tensorflow release, and/or APIs.

Setting the Loss Function in tf.keras.model

Again, various aspects of the machine learning training loop may be customized depending upon the particular application requirements. Aspects include a customization of the loss function implemented by the machine learning training loop used in accordance with the machine learning training flow 300. A loss function is a measure of how well a prediction model (e.g. a machine learning trained model such as one trained in accordance with the machine learning training flow 300) does in terms of being able to predict an expected outcome. Thus, and with continued reference to FIG. 3, the training flow 300 includes the processing portion 250 executing the machine learning training loop to generate the machine learning trained model using any suitable type of loss function.

An example of such a loss function includes the configuration of the training loss in the tf.keras.model fit function, which may introduce restrictions as part of the training setup. The aspects herein describe four examples to overcome these restrictions. Each technique has limitations, some of which are provided in further detail, so that one may be selected based upon specific development needs.

It is first noted that a standard manner of configuring the loss function for training with the model.fit function is via the model.compile (https://www.tensorflow.org/api_docs/python/tf/keras/Model#compile) function, which allows one to enter one or more (or zero) losses through the loss argument. The problem is that the loss function must have the signature loss=fn(y_true, y_pred), where y_pred is one of the outputs of the machine learning training model and y_true is its corresponding label from the training/evaluation dataset. This approach works well for standard loss functions that are clearly dependent on a single model output tensor and a single corresponding label tensor. As used herein, a tensor refers to a multi-dimensional array of a uniform type (called a dtype), which may be implemented in accordance with known techniques via any suitable type of machine learning training algorithm such as Tensorflow, in which all supported dtypes may be accessed via tf.dtypes.DType. In some instances, not only will the machine learning trained model conform to this standard, but one of the default losses provided by tf.keras.losses (https://www.tensorflow.org/api_docs/python/tf/k:eras/losses) may be utilized as well. However, this is typically not the case for most machine learning trained models or loss functions, as often loss functions depend upon multiple outputs and multiple labels, and tend to be much more complex that the default losses offered in standard APIs.

Thus, and as a first example, aspects include implementing a custom training step as part of the machine learning training flow 300 in lieu of the default training step. This may be implemented, for example, by implementing Tensorflow's default training loop as part of the machine learning training flow 300. Each of these examples may thus be implemented as part of the machine learning training flow 300 (e.g. via execution of instructions via one or more processors identified with the processing portion 250), and may implement, as one example, a TensorFlow Keras loss function. The first example of a customized training step includes the use of Flatten and Concatenate functions. For this first alternative, the outputs and labels of the machine learning training model are modified to conform to a required signature. For instance, if the loss function must receive two tensors, y true and y pred, then all of the labels the loss function depends on are flattened and concatenated. Continuing this example, each of the outputs that the loss function depends on are flattened and concatenated into two corresponding tensors.

In other words, the machine learning training loop implemented via the machine learning training flow 300 utilizes a model loss function. This model loss function may function as a software component that is realized via the execution of instructions via one or more processors identified with the processing portion 250, for instance. Regardless of the particular type of model loss function that is implemented in this manner, aspects include the model loss function receiving a plurality of tensors associated with a set of labels of the labeled training data stored in the data storage 103 and providing corresponding model loss function outputs. This process may be performed in accordance with any suitable model loss function techniques used for machine learning model training, including known techniques. In accordance with various aspects, the machine learning training loop functions to flatten and concatenate the set of labels to generate a combined input tensor for the model loss function, and also flattens and concatenates the output tensors of the model loss function to generate a combined output tensor. In this way, the model loss function uses the combined input tensor and the combined output tensor as part of the process of generating the machine learning trained model via the machine learning training loop.

This requires various changes for each loss function that is implemented by the machine learning training flow 300. The first is the addition of two layers to the Tensorflow graph: tf.keras.layers.Flatten and tf.keras.layers.Concatenate. Thus, a model loss function modified in this manner may be represented as a graph having a plurality of layers that include a tf.keras.layers.flatten layer and a tf.keras.layers concatenate layer.

The second change is the addition of a pre-processing routine to the dataset that combines the needed labels into a single label having the same name as the concatenated output. In other words, the one or more processors identified with the processing portion 250 are configured to preprocess the labeled training data by combining any suitable number of (e.g. a set of) labels of the labeled training data into a single label. This single label of the combined set of labels of the labeled training data also has the same label name as the combined output tensor.

Additionally, a separate preprocessing step is implemented as part of the training and evaluation stage 206 to split the combined tensors back into individual tensors. This preprocessing step may be, for instance, prepended to the training computation graph. In other words, the one or more processors identified with the processing portion 250 are configured, as part of the training and evaluation stage 206, to perform additional preprocessing to split the combined input tensors and the combined output tensors back into their respective individual tensors. In this way, the Flatten and Concatenate functions maintain compatibility with currently-implemented and standardized Tensorflow machine learning training functions.

It is noted, however, that the extra steps will introduce some computational overhead. If the model is large, this overhead is negligible, but in some cases this might not be the case. Also, if there are multiple losses and the same tensors are required for more than one loss, then the data is essentially duplicated. Once again, if the model is large, this should be negligible, but if the application is GPU memory bound, or if the training bottleneck is the training data traffic into the GPU, this may need to be considered. Furthermore, this option assumes that the tensors are all of the same data type. For example, if some labels are tf.float and others are tf.int, then suitable type cast operations should be performed before concatenating, which may result in a loss of precision.

A second example includes another option that is referred to herein as the model.add_loss option, the description of which may be found in further detail at https://www.tensorflow.org/guide/keras/train_and_evaluate#handling_losses and_metrics_that_dont_fit_the standard signature, although the examples given are somewhat trivial and do not depend on label data. The add_loss function essentially allows one to add any tensor to the loss calculation. However, an issue with this approach is that this loss tensor cannot rely on tensors that are outside the computation graph. Specifically, this means that any labels that the loss depends on need to be inserted into the graph as inputs (placeholders).

The keras documentation includes an elegant way of handling the labels when employing the add_loss function using an endpoint layer using what is referred to as an endpoint layer, the details of which may be found at https://keras.io/examples/keras_recipes/endpoint_layer_pattern/. But rather than invoking the add_loss on the model after it has been built, this technique calls for defining a custom layer to be placed at the end of the graph, which receives the predictions and targets as inputs, and applies the add_loss in the body of its call function. The output of the layer is the model output. This layer needs to be removed or adjusted for running model.predict( ).

The steps that are required for this second option include:

1. The addition of input layers for each of the labels that the loss depends; and

2. The modification of the dataset by copying or moving all relevant labels to the dictionary of features.

For this second example, the drawbacks to consider include the default loss mechanism enabling one to easily distinguish between different losses and track them separately. In particular, one can easily separate between the regularization factor of the loss and the rest of the losses. When you use add loss, this essentially mixes all losses together, and thus a mechanism is needed for separating them for tracking (e.g. adding the loss tensors to the model outputs or using tf summaries on the individual loss tensors).

Another drawback to the second example is that this technique fails in tf 1 when enabling eager mode, and in tf 2 it only works if one calls tf.compat. v I.disable_eager_execution( ). If one depends on eager execution mode for debugging, this might pose an issue.

A third example includes the generation of a custom layer, which may be in accordance with the Tensorflow training utility or other suitable machine learning training utility. That is, the machine learning trained model may be generated in accordance with any suitable number of model layers, as shown in FIG. 2, which include input layers, output layers, and intermediate layers. This custom layer may represent a custom loss layer and be alternatively referred to herein as a loss calculation layer, which may be implemented as the aforementioned endpoint layer for instance. In accordance with such aspects, instead of calculating the model loss on the “outside” of the machine learning trained model, i.e. using the model inputs and the ground truth, this approach calculates the model loss “inside” of this loss calculation layer. In other words, the machine learning trained model comprises any suitable number of model layers, which also include the custom loss calculation layer such that the loss calculation is performed as part of the machine learning trained model. In other words, aspects include the model loss being calculated as part of the machine learning trained model itself. Thus, the one or more processors identified with the processing portion 250 are configured to generate (e.g. instantiate) the machine learning trained model with the custom loss calculation layer such that the model loss is calculated as the model is trained and evaluated via the machine learning training loop.

This option thus takes the endpoint layer option as noted in the second example above a step further. Specifically, rather than calling the model.add_loss function and outputting the model predictions, the custom loss calculation layer is configured to actually perform the loss calculation and to output the loss result. In other words, depending upon the particular model loss function that is implemented, the loss calculation layer is configured to perform the loss calculation in accordance with that model loss function such that the machine learning trained model outputs a result of the loss calculation. This is in contrast to the conventional use of a machine learning trained model, which typically outputs a prediction that is used together with the ground truth data to calculate the loss. The present aspects utilize the machine learning training model to actually output the loss via one of the model layers, which is then fed to a “dummy” loss function that returns the loss values. To do so, the machine learning trained model that is trained and evaluated via the machine learning training loop as discussed herein may be configured with outputs that include the calculated losses and the model losses (e.g. compile losses), which are then defined to receive the outputs from the loss layers and to return their scalar values untouched. In this way, the loss calculation layer is configured to perform the loss calculation and provide the results of the loss calculation as scalar values

The advantage to this third option, over the second option above, is that it enables a means by which to distinguish between different losses during training by keeping these different losses separate from one another. This solution may be implemented, for instance, by adding a dummy loss target to the dataset stored in the data storage 103 for each model loss function that is implemented in accordance with the machine learning training loop. That is, the labeled training data stored in the data storage 103 may include a dummy loss target for the model loss function that is implemented via the machine learning training loop. A code snippet below defines a new loss calculation in this manner and demonstrates how this custom model layer returns the calculated model loss as part of the machine learning training loop operation.

```
class LossEndPoint(Layer):
  def call(self, predictions, targets):
    # loss_fn is a customized loss function
    loss = loss_fn(predictions, targets)
    return loss
  def compute_output_shape(self, input_shape):
    return [1]
# the compile loss, simply returns the loss scalar
def compile_loss(dummy_target, y_pred):
  return tf.squeeze(y_pred)
```

Similar to the previously-described second example, this technique may also implement entering all of the labels as graph input features, and moving the labels over to the dictionary of features in the dataset. That is, the processing portion 250 as discussed herein may execute instructions to store each one of a plurality of labels used by the machine learning trained model in the data storage 103 (or other suitable storage location) as graph input features. Additionally, the processing portion 250 as discussed herein may execute instructions to relocate each one of the plurality of labels to a dictionary of features in the dataset stored in the data storage 103 (or other suitable storage location). This technique may utilize special handling for calling model.predict( ). For instance, when performing prediction it is desirable that the output of the model be the actual predictions rather than the loss values. This can be accomplished by configuring the model definition (e.g. the definition of the model output) dependent on whether training or prediction is being performed.

A fourth example includes an alternative referred to herein as the backdoor option. For this technique, the model loss function is provided with all of the tensors required in a roundabout way, either by extending the tf.keras.loss function and passing the additional tensors in the constructor, similar to what is described at https://www.tensorflow.org/guide/keras/train_and_evaluate#custom_losses with tensors as the parameters, or by wrapping the loss function within a context that can access all required tensors, as illustrated below in the example code snippet:

def get_keras_loss_fn (pred_dict, true_dict):
def keras_loss (y_true, y_pred):
loss = custom_loss_function(true_dict, pred_dict)
return loss
return keras_loss

This solution also requires defining input layers (placeholders) for the labels, as well as moving the labels over to the dictionary of features in the dataset. As an illustrative example, it is assumed that the loss function receives a y_true and y_pred pair, which it ignores, and instead applies the loss function on the tensors that were entered to the constructor. The loss function still needs to be associated, by name, with a designated model prediction and target. Either may be selected arbitrarily, or a “dummy” output and label may be generated for this purpose. The advantages to this technique is that it does not require flattening/concatenating/casting, but still enables one to maintain separate losses. The one drawback is that, as with the second option described above, the technique is executed only when eager execution is disabled.

An additional point of comparison between the different options should be time performance. This is likely to change from model to model. For large models, the runtime of each of the options were similar when tested, with a slight (3%) advantage to the first and third options over the “add loss” option.

Customizing Training Loops Using tf.keras.callbacks

The tf.keras.callbacks (see https://www.tensorflow.org/api_docs/python/tf/keras/callbacks) APIs enable the insertion of logic at different stages of the training/evaluation loop. TensorFlow offers a number of callbacks for updating the learning rate (LearningRateScheduler), saving checkpoints (ModelCheckpoint), early stopping (EarlyStopping), logging to Tensorboard (TensorBoard), and more. But perhaps most importantly, TensorFlow enables the creation of custom callbacks. These enable the insertion of customizations during the training flow.

In the example developmental flow described herein, these customizations were used to track the training progress, collect statistics, and spawn evaluations on other instances, for instance. Custom TensorFlow keras callbacks are an important tool the example developmental flow, as the level of customization these provide enable one to rely on the default keras.model.fit training loop API rather than requiring a custom solution. It is noted that because the callbacks introduce computation overhead, their overuse should be avoided. Thus, their frequency is limited as part of the example developmental flow, as is the amount of computation in each call.

VI. Reproducing Training Time Bugs

It is well known that program debugging is an integral part of software development, and that the time that is spent debugging often eclipses the time that it takes to write the original program. Debugging is generally an arduous process, and much has been written about how to design and implement a program to increase the reproducibility of bugs and ease the process of root cause analysis. In machine learning, the task of debugging is complicated by the stochasticity that is inherent to machine learning algorithms, and by the fact that the algorithms are run on dedicated HW accelerators, often on remote machines.

Debugging in TensorFlow is further complicated due to the use of symbolic execution (i.e. graph mode), which boosts the runtime performance of the training session but, at the same time, limits the ability to freely read arbitrary tensors in the graph, a capability that is important for debugging. In this Section, the difficulties of debugging TensorFlow training programs are further discussed and the aspects described herein provide techniques for how to address those difficulties.

As discussed herein, debugging refers to the art of identifying a bug, either in the code or in the data, which causes a training session to abruptly break down. This is in contrast to other types of debugging that may refer to the task of fixing or tuning a model that is not converging or is producing unsatisfactory predictions on a certain class of inputs (e.g. a vehicle detection model that is failing to identify pink cars).

As part of the machine learning model training process as discussed herein, bugs may be encountered and need to be addressed. Such bugs may include various issues that are relatively easy to reproduce. This may include, for instance, machine learning models constructed with an assumption on the sizes of the input tensors that does not match the training data, trying to concatenate mismatched tensors, or performing a tf operation on an invalid data type. These usually do not depend on specific model states and data, and are typically relatively easy to reproduce. Other bugs, which may be considerably more difficult to diagnose, may occur sporadically and unpredictably. This may include, for instance, bugs that are reproduced only on a specific state of the machine learning trained model, a specific data sample, or a specific combination of the model state or data inputs.

Specifically, training time bugs are difficult to identify in a deterministic fashion. Moreover, because training may run for a long period of time, the model state may be different prior to when a model training fails, and it is difficult to determine the state of the model at the time the failure occurred. As one example, while training with TensorFlow, a bug may be encountered that causes the training to break, i.e. the training loss to jump to NaN (not a number). Sometimes this will happen on a specific combination of the data input and model state, as noted above. The issue, however, is that once it is identified that the loss has turned to NaN, the model state has already changed, rendering the previous model state, as well as the data that broke the training, irretrievable.

Traditional solutions to solve this problem include attempting to reproduce the bug by rerunning the training from the same initial state, or resuming from a recent model checkpoint and using the same data sequence in a debug friendly environment. However, this option has a number of disadvantages. For instance, the bug may be “hit” many days after starting the training, or many hours after the last model was resumed, which means that reproducing in this manner could take a long time. Furthermore, running in a debug friendly environment (e.g. TensorFlow eager execution mode) typically takes much longer than running in the default (e.g. graph) execution mode, significantly increasing the reproduction time. Still further, to ensure reproduction, the training must restart/resume in precisely the same state, and on the same point, in the data sequence. Since training typically includes many random variables, ensuring this might require a great deal of bookkeeping overhead, and would be particularly difficult if the model includes non-deterministic operations.

The aspects described in further detail in this Section address these aforementioned issues of debugging a machine learning model training process, which may be particularly useful to identify bugs that are dependent upon the model state and/or input data. This is accomplished, as further discussed in this Section, via the creation and use of a custom training loop. The machine learning training loop as discussed herein with reference to FIGS. 2 and 3, for example, implements an iteratively-executed training function, which may be a standardized or default Tensorflow training function, to generate the machine learning trained model. Again, the machine learning training loop executes any suitable number of training steps by applying forward and backward passes on the training loop data (e.g. in stage 4 of FIG. 3 as noted herein) to generate the machine learning trained model to enable machine vision to recognize and classify objects included in a road scene. For each training step in the machine learning training loop, a forward pass is performed in accordance with machine learning trained model to calculate the current loss value given the current model weights. Then, the model weights are updated at the end of each training step by calculating gradients of the loss function with respect to each of the weights in their present state. A gradient pass is performed via each backward pass on the machine learning loop to calculate the updates to the model weights. Thus, the model gradients as referred to herein may include a calculation to the updates of the model weights during each training iteration or step.

The aspects described in this Section utilize a custom training loop that is implemented as a custom training function configured to override the TensorFlow training loop such that model data is stored at each training step, the model gradients are tested at each step with respect to their validity, and then them model gradients are used to update the model weights only when the model gradients have valid values. The model data in this context may include any suitable type of data associated with the inputs, outputs, and/or state of the machine learning trained model. For instance, the model data may comprise data features and labels used by the machine learning trained model, weights, model gradients (e.g. gradient values), machine learning trained model outputs (e.g. predictions), loss calculations, etc. The custom training loop is generated by defining a custom class that derives from the base class, in which any relevant number of functions that are typically used as part of the Tensorflow training loop are overridden, as further discussed with respect to the code provided in this Section.

Aspects include the custom training function being configured such that any suitable type of flag is established that indicates an error condition, which may be an invalid (e.g. not a number (NaN) value) for the model gradients in this example. The iteratively-executed training function is configured to detect the error by comparing the model gradients at each respective one of the plurality of training steps to a predetermined value, such as a NaN value for instance. The one or more processors identified with the processing portion 250 are thus configured to execute the machine learning training loop in accordance with the custom iteratively-executed training function such that, in response to an error being detected, execution of the machine learning training loop is halted and any suitable type of model data (e.g. data features, labels, model weights, etc.) are then stored in the data storage 103 or other suitable storage device. Continuing this example, the aspects described in this Section enable the model gradients to be detected as invalid at one of several training steps executed in the machine learning training loop and, when such an error is detected, the data features, labels, and a state of the machine learning trained model (e.g. the model weights at the time of the error or other suitable data as noted herein) are saved corresponding to that particular training step at which the error was detected.

In this way, the instantiated iteratively-executed training function is configured to compare (i.e. cause the one or more processors of the processing portion 250 to compare via execution of the function) the gradient values at each training step to a predetermined value prior to applying the gradient values to the model weights used in accordance with the machine learning training loop. This allows the ability to maintain and save the original model state and data for later reproduction and analysis in a debug friendly environment. This technique enables easy reproduction and discovery of programming bugs in TensorFlow applications and/or data.

To provide an illustrative example, the iteratively-executed training function may comprise a customized implementation of a tk.keras.models.Modei object used in accordance with Tensorflow. Thus, the aspects described in this Section may override the train_step and make_train_functions routines used in accordance with the tf.keras.models.Model object with customized implementations thereof. The customized machine learning training loop thus stores the model data features and labels (x and y) at each training step, as noted above. When an error is encountered (e.g. the model gradients are invalid), a suitable error flag or signal is sent to the training loop (e.g. processors identified with the processing portion 250) that an error was encountered. An example of such an error flag or signal may be setting the loss to a predetermined value such as zero or NaN.

As noted in further detail below with respect to the sample code, the tf.keras.models.Model object may comprise a class that defines a Boolean flag to signal to the iteratively-executed training function whether the error was detected. The customized class has a Boolean flag to signal to the machine learning training model main function whether an error was encountered. The main function will thus receive this signal and store any suitable type of model data, the model state, data for reproduction, etc., in a debug environment (such as TensorFlow eager execution mode). An example of this custom training function configured to override the TensorFlow training loop is illustrated in the example code portion below.

| | |
|---|---|
| 1. | class CustomKerasModel(tf.keras.models.Model): |
| 2. | def_init_(self, **kwargs): |
| 3. | super(CustomKerasModel, self)._init_(**kwargs) |
| 4. | # boolean flag that will signal to main function that an error was encountered |
| 5. | self.crash = False |
| 6. | @tf.function |
| 7. | def train_step(self, data): |
| 8. | x, y = data |
| 9. | with tf.GradientTape( ) as tape: |
| | y_pred = self(x, training=True) # Forward pass |
| | # Compute the loss value |
| | # (the loss function is configured in 'compile( )') |
| | loss = self.compiled_loss(y, y_pred, regularization_losses=self.losses) |
| 10. | res = {'loss': loss} |
| 11. | # Compute gradients |
| 12. | trainable_vars = self.trainable_variables |
| 13. | gradients = tape.gradient(loss, trainable_vars) |
| 14. | # concatenate the gradients into a single tensor for testing |
| 15. | concat_grads = tf.concat([tf.reshape(g,[−1]) for g in gradients],0) |
| 16. | # In this example, we test for NaNs, but we can include other tests |
| 17. | if tf.reduce_any(tf.math.is_nan(concat_grads)): |
| | # if any of the gradients are NaN, send a signal to the outer loop and halt the training |
| | # we choose to signal to the outer loop by setting the loss to 0. |
| | return {'loss': 0.} |
| 18. | else: |
| | # Update weights |
| | self.optimizer.apply_gradients(zip(gradients, trainable_vars)) |
| | return {'loss': loss} |
| 19. | def make_train_function(self): |
| 20. | if selftrain_function is not None: |
| | return self.train_function |
| 21. | def train_function(iterator): |
| | data = next(iterator) |
| | # records the current sample |
| | self.x, self.y = data |
| | res = self.train_step(data) |
| | if res['loss'] = = 0.: |
| | self.crash = True |
| | raise Exception( ) |
| | return res |
| 22. | self.train_function = train_function |
| 23. | return self.train_function |
| 24. | if_name_= = '_main_ ': |
| 25. | # train_ds = |
| 26. | # inputs = |
| 27. | # outputs = |
| 28. | # optimizer = |
| 29. | # loss = |
| 30. | # epochs = |
| 31. | # steps_per_epoch = |
| 32. | model = CustomKerasModel(inputs=inputs, outputs=outputs) |
| 33. | opt = tf.keras.optimizers.Adadelta(1.0) |
| 34. | model.compile(loss=loss, optimizer=optimizer) |
| 35. | try: |
| 36. | model.fit(train_ds, epochs=epochs, steps_per_epoch=steps_per_epoch) |
| 37. | except Exception as e: |
| 38. | # check for signal |
| 39. | if model.crash: |
| | model.save_weights('model_weights.ckpt') |
| | # pickle dump model.x and model.y |
| | features_dict = { } |
| | for n, v in model.x.items( ): |
| | features_dict[n] = v.numpy( ) |
| | with open('features.pkl','wb') as f: |
| | pickle.dump(features_dict,f) |
| | labels_dict = { } |
| | for n, v in model.y.items( ): |
| | labels_dict[n] = v.numpy( ) |
| | with open('labels.pkl', 'wb') as f: |
| | pickle.dump(labels_dict, f) |
| | raise e |

With reference to the sample code above, the first line represents an instantiation of the custom tf.keras.model. Line 36 defines a custom model.fit training function, which represents the functionality associated with iteratively-executed training function as discussed herein. The model.fit training function is further wrapped in a “try catch loop,” which begins at line 35 and enables the custom training function to “catch” defined exceptions as further discussed below.

Line 17 defines the statement if tf.reduce_any(tf.math.is_nan(concat_grads)), which is identified with the model gradient validity test noted above in this Section. In this example, if any of the model gradients are NaN, then a signal is sent to the outer loop and the training is halted. The signal in this example is implemented by setting the loss to 0. The following line 18 defines an else statement that occurs only when the model gradient values are valid, i.e. the if statement in line 17 is false. In this example, the model gradients are used to update the model weights when the model gradients are valid.

The code sample above also includes the addition of line 21, in which the custom training function is defined. The training function is configured in this example such that the aforementioned error signal is detected by identifying the condition in which the loss=0. When this occurs, the switch self.crash flag is set to true, which represents a different signal than the signal used to capture the data features, labels, model state, etc. of the machine learning trained model. The various data that is captured at the training step at which the self.crash flag is set to true corresponds to when an error occurs at that training step, which is enabled via the third nested line under line 21 “self.x, self.y=data.” This is in contrast to a conventional training loop that does not capture the data features (e.g. data samples) during each training step. Because of this particular line of code, in the event that a crash occurs, the model data may be accessed from a saved location (e.g. the storage 103). In this context, the data self.x may refer to the frame input to the machine learning trained model, whereas the self.y may refer to the ground truth data. In other words, the self.x data functions as an input to the machine learning trained model, which then outputs a prediction as noted above. The ground truth data self.y may be analyzed by the loss function with the predictions output by the trained model to calculate the loss as discussed herein.

Line 37 defines the exception e, which is identified with the detection of a crash state (e.g. the model gradients are invalid). When this occurs, the following lines 38-39 define a procedure for recording and saving (e.g. to the storage 103) the current model data and state information as noted herein. As shown in lines 38-39, the model weights are saved along with the model features and labels. Because of the manner in which the signal or flag is defined in line 17, the model data and state are saved in lines 38-39 without applying the invalid gradients to the model weights, which would otherwise invalidate the machine learning trained model.

Furthermore, because the data.x and data.y values were saved via the defined training function at line 21, the code provided at line 39 enables the various data model weights, features, and labels to be saved by iterating over model.x and model.y, respectively, creating a dictionary of entries for each, and then dumping (i.e. saving) this data to a suitable location (e.g. the storage 103).

This allows a user to load the stored weights, model data (e.g. x and y features), and labels and to feed this data to a suitable debugging tool that may enable a user to step through the forward and backward iterations of the machine learning training loop to identify the bugs responsible for the crashed state at a training step at which the gradient values were invalid.

VII. Using Custom Layers to Capture Tensors During Training

Again, and with reference to FIGS. 2 and 3, the processing portion 250 may implement any suitable type of training loop to generate the machine learning trained model over multiple iterations, as noted above. As discussed herein, the machine learning trained model is comprised of multiple layers, the number and type of layers (e.g. input layers, output layers, hidden layers, convolve (CONV) layers, dense layers, etc.) depending upon the particular application and training loop data. For Tensorflow in particular, the model layers are defined such that the outputs of one layer are fed into the next layer, which is also shown in FIG. 2. Thus, each layer constitutes a particular operation that is performed by the machine learning training model as the machine learning training loop is iteratively executed. The aspects described in this Section are based upon observations that layer weights used in accordance with these model layers, including non-trainable weights, are eager tensors.

As noted above, TensorFlow uses symbolic execution (i.e. graph mode), which boosts the runtime performance of the training session but limits the ability to freely read arbitrary tensors in the graph. There are various reasons to access arbitrary graph tensors during a TensorFlow training session, the most important being the need to monitor the learning session (e.g. by posting tensor metrics to TensorBoard) and debugging bugs in the model definition or data. Version 2 of TensorFlow has made extracting arbitrary graph tensors more difficult than in the past for several reasons.

First, revisions to the TensorFlow summary mechanism are such that summary operations (ops) are no longer part of the computation graph, and tf summaries must be called on eager tensors or raw numpy tensors. Thus, internal graph tensors must somehow be extracted before recording the graph tensors to the TensorBoard event file.

A second difficulty is related to the execution modes implemented by Tensorflow, and Tensorflow 2 in particular. One of these modes is the eager execution mode, which is similar to a debug mode of operation, whereas another mode is the graph mode, which is what is typically used at run time or during production. Thus, tensors that are created within the eager execution scope are called eager tensors, and can be accessed freely. But TensorFlow 2 applications run in graph mode at run-time for production-based training processes, as the eager mode considerably slows down the training process. To improve runtime performance, e.g. during training, one can configure functions to run in graph mode by applying the tf.function qualifier to the functions. This happens automatically when relying upon the high level model.fit( ) training API. This means that each of the tensors defined as part of a model, aside from the tensors that are defined as outputs of the tf.function, will be graph (e.g. non-eager) tensors. Thus, during production-based training that implements graph mode, the tensor values cannot be accessed freely in contrast to the use of eager mode.

A third difficulty is related to the use of functions instead of sessions. For instance, in Tensorflow 1 (tf1), the underlying mechanism for extracting the values of graph tensors was the tf.session object. The session.run( ) function was thus provided with a list of graph operations and input values to receive the values of the corresponding tensors as output. In Tensorflow 2 (tf2), however, the sessions have been replaced by functions, specifically tf.functions when running in graph mode. One useful property of the session.run( )method was the freedom in determining the list of input ops, and thus the list of collecting tensor values. This was particularly useful for extracting summaries. For instance, at every predetermined summary step, the list of input ops could thus be expanded to include the tensors of interest. Doing so using tf.functions in tf2 is not as straightforward.

Previous solutions to address these issues include the use of Legacy Mode. Using legacy mode, one may disable the eager execution by calling tf.compat.v1.disable_eager_execution at the beginning of a script. When this function is used, the training loop essentially falls back to the legacy tf 1 training loop, and the to mechanism for extracting tensors can be used. However, there are a number of TensorFlow features that are not supported when using legacy mode, such as train step customization and tf profiling, for example. In addition, when using legacy mode, one does not enjoy the most up-to-date tf optimizations and enhancements.

Thus, another solution includes the use of a custom Training Loop. In other words, and as noted above, TensorFlow provides support for customizing the training step. One can take advantage of the relative freedom that customization provides to support capturing graph tensors. In particular, the training step function can be defined to return all tensors of interest, including the tensors one wishes to monitor. However, using the custom training loop option may incur a significant performance penalty due to the overhead of returning a superset of all tensors of interest for every training iteration. A mechanism that toggles between multiple tf.functions, some including just the prediction tensors, and others including tensors for monitoring, would be required for making this method feasible.

Tensorflow enables the ability for users to define custom layers, which may thus form part of the model layers as noted above, and which may be particularly useful to perform functionality in a layer that is not provided by the default Tensorflow layers. The aspects described in this Section thus address the aforementioned issues by leveraging the use of custom Tensorflow Keras (tf.keras) layers by defining layers that record input tensors as non-trainable layer weights. For instance, these tensors may be stored as eager tensors, and thus are freely accessible (e.g. from tf.keras callbacks). In this way, other than recording the input values, the layer passes through the input untouched. This technique provides a simple and elegant way to capture graph tensors during training of the machine learning trained model.

The custom layers described in this Section may not perform calculations in accordance with the machine learning trained model, but instead function to capture the state of any suitable type of tensors used by the machine learning training model during training such that the tensor values may then be observed. The tensors recoded in this manner may constitute any suitable type and/or number of tensors depending upon where the custom capture layer is provided with respect to each of the layers in the machine learning trained model. This may include input tensors (e.g. tensors provided as inputs to the input layer(s)), output tensors (e.g. tensors provided as outputs by the output layer(s)), or intermediate tensors (e.g. tensors generated, received, and/or otherwise utilized by the layers between the input and the output layers). The intermediate tensors captured in this manner may advantageously constitute, for instance, tensors identified with the model loss function used by the machine learning trained model. In any event, the tensors that are captured in this manner may be stored by the one or more processors identified with the processing portion 250 in the data storage 103 or other suitable storage location. To do so, the value of a given graph tensor may be stored by assigning each recorded tensor value to a “non-trainable” weight, which may be stored for example as internal non-trainable weight variables. Again, the captured tensors may comprise multi-dimensional arrays of a uniform type.

The aspects described in this Section are with respect to the implementation of a custom tf.keras layer, although this is by way of example and not limitation, and the aspects described herein may be extended to any suitable type of machine learning training utility. The custom layer configured in accordance with the aspects described in this Section may alternatively be referred to herein as a capture layer or a summary layer. The aspects described in this Section facilitate the ability to probe or identify the state of any suitable number and type of tensors used by the machine learning trained model during the training process, which may be at run-time or during production and in accordance with Tensorflow 2, for instance. As noted herein, the ability to access the state of these tensors in this way is typically not available during the training process unless eager mode is used, which considerably slows down training.

Continuing the example of a custom tf.keras layer, the example block of code below functions to generate a custom tf.keras layer that extends the standard tf.keras InputLayer with another layer that includes a non-trainable weight, referred to in the code block below as “record_input.” The call function is enhanced such that at each step, the record_input field is updated with the value of the current input. Since this is an eager tensor, the record_input can be read outside of the training loop and may be recorded, for instance, to TensorBoard. Although the following code block illustrates the ability to record the value of a graph input tensor, the aspects described in this Section may be extended to capture any suitable type of tensor used by the machine learning trained model. The custom capture layer thus functions to cause the one or more processors identified with processing portion 250 to store the input tensors, which are provided as inputs to the model input layer, in the data storage 103 (or other suitable storage device) during execution of each iteration (or any suitable number of iterations) of the machine learning training loop as discussed herein with respect to FIGS. 2 and 3.

| | |
|---|---|
| 1. | class InputRecorderLayer(tf.keras.layers.InputLayer): |
| 2. | def_init_(self, shape, dtype, name): |
| 3. | self.record_input = tf.Variable( |
| | shape=[None]+list(shape), |
| | # initialize with batch size 1 since batch_size is unknown, and set |
| | validate_shape=False |
| | initial_value=tf.zeros(shape=[1]+list(shape), dtype=dtype), |
| | validate_shape=False, |
| | dtype=dtype, |
| | trainable=False) |
| 4. | input_layer_config = {'name': name, 'dtype': dtype, 'input_shape': shape} |
| 5. | super(InputRecorderLayer, self)._init_(**input_layer_config) |
| 6. | def capture(self,inputs): |
| 7. | self.record_input.assign(inputs) |
| 8. | def call(self, inputs, **kwargs): |
| 9. | self.capture(inputs[0]) |
| 10. | return super(InputRecorderLayer, self).call(inputs, **kwargs) |
| 11. | def InputRecorder(shape=None,name=None,dtype=None): |
| 12. | input_layer = InputRecorderLayer(shape,name,dtype) |
| 13. | outputs = input_layer._inbound_nodes[0].output_tensors |
| 14. | if len(outputs) = = 1: |
| 15. | outputs = outputs[0] |
| 16. | return input_layer, outputs |
| 17. | # when building the graph maintain a reference to the layer |
| 18. | frame_input_layer, frame = InputRecorder(shape=[height,width,channels], |
| | dtype=tf.uint8, name='frame') |
| 19. | . . . #build rest of graph with frame as input |
| 20. | # train the model (model.fit( )) |
| 21. | # access recorded input as needed |
| 22. | # Creates a file writer for the log directory. |
| 23. | file_writer = tf.summary.create_file_writer(logdir) |
| 24. | with file_writer.as_default( ): |
| 25. | tf.summary.image(“input frame”, frame_input_layer.record_input, step=step) |

To do so, and with reference to the line 2 of the code block above, the def_init function acts as a constructor and creates a placeholder that is a variable that is updated with the current value of the input tensor to the input layer for subsequent machine learning training loop iterations. This variable may be accessed later to read the value of the recorded input tensor (in this example), such as from the data storage 103.

Line 8 defines the call function def call(self, inputs, **kwargs), which introduces the functionality used for the custom layer. In this example, the selfrecord_input.assign(inputs) as indicated in line 7 uses the assign operation to update the recorded inputs to the model input layer with the current value of those inputs. The call function thus defined returns the values of the inputs to the model input layer as updated at each iteration of the machine learning training loop, as indicted in line 9 via the use of selfcapture(inputs[0]).

Moreover, and with reference to line 18, the substitution of the default Tensorflow Keras input layer by the input recorder layer, or custom capture layer, is shown by frame_input_layer, frame=InputRecorder. This modifies the first input layer as the custom capture layer instead of the use of default model input layer. Line 19 includes additional layers that are used, which are not shown in further detail for purposes of brevity.

It is noted that in the definition of the non-trainable tf.Variable, an arbitrary batch_size, is used in the initialization value, with validate_shape being set to False. This is because, while the initial value requires a well-defined shape (it cannot include ‘None’ in any of the dimensions), at the time of creation it is not known what the batch_size will be. The advantage of constructing the tf.Variable in this manner, rather than fixing the batch_size, is that this custom layer may still be implemented and a JSON model configuration may be used. However, this is optional.

Again, the machine learning trained model comprises several layers, which include input and output layers and any other suitable number and type of intermediate layers between the input and the output layers. The example code block provided above is with respect to the input layer of the machine learning trained model, as Tensorflow treats the input layer differently than the other layers, and therefore this example was provided to account for these differences.

However, additionally or alternatively, the capture layer used to capture intermediate tensors as discussed herein may include a custom general purpose summary capture layer. That is, to support the general case of capturing a graph tensor, a general purpose tensor capture layer may be defined. This custom summary layer is defined as a pass through for the input, where the custom summary layer causes the one or more processors identified with the processing portion 250 to store a current value as an internal non-trainable weight variable. This may thus be used to capture tensors at any stage in the graph, including layer inputs and outputs, as well as tensors in the loss function. Additionally, this may be used to capture tensors in the input pipeline, which is not achieved by conventional solutions.

The example code block below illustrates the manner in which a general custom summary layer may be constructed to facilitate the capturing of intermediate tensors, for example, or any other suitable tensors as part of the machine learning training loop (e.g. output tensors). The custom capturer layer used for this more general case to capture these non-input tensors is referenced herein as a custom summary layer, but such a custom summary layer is also considered a custom capture layer as this term is used herein.

| | |
|---|---|
| 1. | class SummaryCaptureLayer(tf.keras.Layer): |
| 2. | # the shape input must be fully defined (including the batch size) |
| 3. | def_init_(self, shape, name, dtype): |
| 4. | self.record_tensor = tf.Variable( |
| | # initialize with batch size 1 since batch_size is unknown, and setvalidate_shape=False |
| | initial_value=tf.zeros(shape=[1]+shape[1:], dtype=dtype), |
| | validate_shape=False, dtype=dtype, |
| | trainable=False) |
| 5. | super(SummaryCaptureLayer, self)._init_(trainable=False, name=name, dtype=dtype) |
| 6. | def capture(self,inputs): |
| 7. | self.record_tensor.assign(inputs) |
| 8. | def call(self, inputs, **kwargs): |
| 9. | self.capture(inputs) |
| 10. | return inputs |

The custom summary layer may be implemented to capture intermediate tensors, which may be utilized by any of the layers between the input and the output layers, by interleaving the custom capture layer between the input layer, the output layer, or between any two of the intermediate layers that are between the input and the output layers. Regardless of which two layers the custom capture layer is interleaved between as discussed herein, these two layers may be referred to alternatively as “first” and “second” layers. In this way, and as further discussed below, the custom summary layer is configured to capture intermediate tensors that are output by a first machine learning model layer and input to a second machine learning model layer. The custom summary layer thus functions to cause the one or more processors identified with processing portion 250 to store the intermediate tensors in the data storage 103 (or other suitable storage device) during execution of the machine learning training loop as discussed herein with respect to FIGS. 2 and 3.

To do so, and with reference to the line 2 of the code block above, the def_init function acts as a constructor and creates a placeholder that is a variable that is updated with the current value of the intermediate tensor for subsequent machine learning training loop iterations. This variable may be accessed later to read the value of the recorded input tensor (in this example), such as from the data storage 103. Again, the custom summary layer may function to not perform an actual calculation for the machine learning trained model, but to record (i.e. store) the values of the intermediate tensors by assigning each recorded intermediate tensor value to a non-trainable weight, which may be stored for example as internal non-trainable weight variables.

Line 8 defines the call function def call(self, inputs, **kwargs): that introduces the functionality used for the custom summary layer. In this example, and as indicated in line 7, the assign self.record_tensor.assign(inputs) operation is implemented to update the recorded intermediate tensor values with the current values. The call function thus defined returns the values of the intermediate tensor values as updated at each iteration of the machine learning training loop.

Aspects further include storing a reference to the created custom layer and then accessing the record_tensor field, as needed, as shown in the previous example. To do so, the shape that is entered to the constructor should be fully defined, an example being shown in line 4 for self.record_tensor.

Thus, the aspects described in this Section may refer to the custom layer as either a custom “capture layer,” or a custom “summary layer,” to provide examples for recording tensor summaries to TensorBoard, which may include input tensors, intermediate tensors, output tensors, or any other suitable tensors as noted herein. Alternatively, the custom capture layer or the custom summary layer may be referred to as the “TensorCaptureLayer,” as the tensor may be considered as being captured in this regard. Capturing tensors may support additional needs such as debugging, for instance, and may allow for the analysis of tensor values during production training while advantageously increasing training speed, as access to the tensors during the production training process would not otherwise be possible as this is not provided by Tensorflow 2.

Naturally, adding custom summary layers to the model, however thin these may be, may incur a performance penalty. But since the performance penalty will depend directly on the model architecture, the number of custom summary layers that are inserted, and the frequency at which the tensors are written to the event file, should be evaluated on a case-by-case basis.

### EXAMPLES

The following examples pertain to further aspects

Example 1. A machine learning model training system, comprising: one or more processors; and a memory configured to store instructions that, when executed by the one or more processors, cause the one or more processors to: receive labeled training data from a data storage; preprocess the labeled training data to generate training loop data; and perform, via a machine learning training loop, training and evaluation of the training loop data in accordance with a defined model loss function to generate a machine learning trained model that enables machine vision to recognize and classify objects included in a road scene, wherein the model loss function receives a plurality of tensors associated with a set of labels of the labeled training data and provides model loss function outputs, wherein the machine learning training loop (i) flattens and concatenates the set of labels to generate a combined input tensor, and (ii) flattens and concatenates the model loss function outputs to generate a combined output tensor, and wherein the model loss function uses the combined input tensor and the combined output tensor to generate the machine learning trained model.

Example 2. The machine learning model training system of Example 1, wherein the one or more processors are configured to preprocess the labeled training data by combining the set of labels of the labeled training data into a single label.

Example 3. The machine learning model training system of any combination of Examples 1-2, wherein the single label of the combined set of labels of the labeled training data have the same name as the combined output tensor.

Example 4. The machine learning model training system of any combination of Examples 1-3, wherein the one or more processors are configured, when executing the instructions stored in the memory, to perform an additional preprocessing using the model loss function to split the combined input tensors and the combined output tensor tensors back into respective individual tensors.

Example 5. The machine learning model training system of any combination of Examples 1-4, wherein the model loss function is represented as a graph having a plurality of layers that include a tf.keras.layers.flatten layer and a tf.keras.layers concatenate layer.

Example 6. The machine learning model training system of any combination of Examples 1-5, wherein the model loss function compromises a TensorFlow Keras loss function.

Example 7. A machine learning model training system, comprising: one or more processors; and a memory configured to store instructions that, when executed by the one or more processors, cause the one or more processors to: receive labeled training data from a data storage storing a training dataset; preprocess the labeled training data to generate training loop data; and perform, via a machine learning training loop, training and evaluation of the training loop data in accordance with a model loss function to generate a machine learning trained model that enables machine vision to recognize and classify objects included in a road scene, wherein the machine learning trained model includes a plurality of layers, the plurality of layers including a loss calculation layer configured to perform a loss calculation in accordance with the model loss function such that the machine learning trained model outputs a result of the loss calculation.

Example 8. The machine learning model training system of Example 7, wherein the result of the loss calculation are provided by the loss calculation layer as scalar values.

Example 9. The machine learning model training system of any combination of Examples 7-8, wherein labeled training data includes a dummy loss target for the model loss function.

Example 10. The machine learning model training system of any combination of Examples 7-9, wherein the one or more processors are configured to, when executing the instructions stored in the memory: store each one of a plurality of labels used by the machine learning trained model in the data storage as graph input features; and relocate each one of the plurality of labels to a dictionary of features in the dataset stored in the data storage.

Example 11. The machine learning model training system of any combination of Examples 7-10, wherein the model loss function comprises a TensorFlow Keras loss function.

Example 12. A machine learning model training system, comprising: one or more processors; and a memory configured to store instructions that, when executed by the one or more processors, cause the one or more processors to: receive labeled training data from a data storage; preprocess the labeled training data to generate training loop data; and execute a plurality of training steps as part of a machine learning training loop that utilizes the training loop data to generate a machine learning trained model that enables machine vision to recognize and classify objects included in a road scene, wherein the machine learning training loop uses an iteratively-executed training function that stores, at each one of the plurality of training steps, data features and labels used by the machine learning trained model, and wherein the iteratively-executed training function is configured, in response to detecting an error corresponding to model gradients being invalid at a respective one of the plurality of training steps, to stop execution of the machine learning training loop and to store, in the data storage, the data features, labels, and a state of the machine learning trained model corresponding to a respective one of the plurality of training steps at which the error was detected.

Example 13. The machine learning model training system of Example 12, wherein the iteratively-executed training function is configured to detect the error by comparing the model gradients at each respective one of the plurality of training steps to a predetermined value.

Example 14. The machine learning model training system of any combination of Examples 12-13, wherein the model gradients comprise gradient values, and wherein the iteratively-executed training function is configured to compare the gradient values at each respective one of the plurality of training steps to the predetermined value prior to applying the gradient values to model weights used in accordance with the machine learning training loop.

Example 15. The machine learning model training system of any combination of Examples 12-14, wherein the predetermined value is identified with a Not a Number (NaN) value.

Example 16 The machine learning model training system of any combination of Examples 12-15, wherein the state of the machine learning trained model stored in the data storage comprises model weights corresponding to a respective one of the plurality of training steps at which the invalid the model gradients were detected.

Example 17. The machine learning model training system of any combination of Examples 12-16, wherein the iteratively-executed training function comprises a tf.keras.models.Model object used in accordance with Tensorflow.

Example 18. The machine learning model training system of any combination of Examples 12-17, wherein the tf.keras.models.Model object comprises a class that defines a Boolean flag to signal to the iteratively-executed training function whether the error was detected.

Example 19. A machine learning model training system, comprising: one or more processors; and a memory configured to store instructions that, when executed by the one or more processors, cause the one or more processors to: receive labeled training data from a data storage; preprocess the labeled training data to generate training loop data; and execute a machine learning training loop that utilizes the training loop data to generate a machine learning trained model that enables machine vision to recognize and classify objects included in a road scene, wherein the machine learning trained model comprises a plurality of layers, the plurality of layers including a capture layer interleaved between a first layer and a second layer of the plurality of layers and configured to capture intermediate tensors that are output by the first layer and input to the second layer, and wherein the capture layer causes the one or more processors to store the intermediate tensors in the data storage.

Example 20. The machine learning model training system of Example 19, wherein the intermediate tensors are multi-dimensional arrays of a uniform type.

Example 21. The machine learning model training system of any combination of Examples 19-20, wherein the capture layer is configured to cause the one or more processors to store the intermediate tensors as an internal non-trainable weight variable.

Example 22. The machine learning model training system of any combination of Examples 19-21, wherein the machine learning training loop utilizes the training loop data to generate the machine learning trained model in accordance with a model loss function, and wherein the capture layer causes the one or more processors to store, as the intermediate tensors in the data storage, tensors identified with the model loss function.

Example 23. The machine learning model training system of any combination of Examples 19-22, wherein the capture layer does not perform calculations in accordance with the machine learning trained model.

Example 24. The machine learning model training system of any combination of Examples 19-23, wherein the capture layer comprises a TensorFlow Keras layer.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

A “ground vehicle” may be understood to include any type of vehicle, as described above, which is driven on the ground, e.g., on a street, on a road, on a track, on one or more rails, off-road, etc.

The term “autonomous vehicle” may describe a vehicle that implements all or substantially all navigational changes, at least during some (significant) part (spatial or temporal, e.g., in certain areas, or when ambient conditions are fair, or on highways, or above or below a certain speed) of some drives. Sometimes an “autonomous vehicle” is distinguished from a “partially autonomous vehicle” or a “semi-autonomous vehicle” to indicate that the vehicle is capable of implementing some (but not all) navigational changes, possibly at certain times, under certain conditions, or in certain areas. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

### Appendix: Performance Analysis Tools—TensorFlow Metrics

Evaluating Results Using tf.keras.metrics

Another important tool for tracking the progress of training are tf.keras.metrics (https://www.tensorflow.org/api_docs/python/tf/keras/metrics). As with tf.keras.callbacks, TensorFlow provides several default metrics, as well as the option to implement a custom metric class. Similar to tf.keras.losses, the metric “update_state” function should conform to a specific signature def update_state(self, y_true, y_pred, sample_weight=None), that does not always align with a particular application. In this example developmental flow this is performed in a similar manner to the loss constraint solution (by flattening and concatenating, calling the model.add_metric function, and/or passing in additional dependencies in a backdoor fashion).

The metrics are set via the model.compile (https://www.tensorflow.org/api_docs/python/tf/keras/Model#compile) function, and can be modified based on one's needs or the particular application (e.g. whether training or evaluation is running). Contrary to keras callbacks, but similar to keras losses, metrics are part of the computation graph and run in the GPU. Such metrics should be chosen and implemented carefully so as not to introduce unnecessary computational overhead.

Collecting TensorFlow Summaries in tf.keras

In this example developmental flow, TensorBoard summaries are used for tracking and debugging the training. Losses were tracked, gradient histograms generated, and activation outputs then measured. Metrics were logged, confusion matrices displayed, and visual images generated from the output data. TensorBoard may be used to debug intermediate operations performed by the loss function, or to measure the distribution of weights on a specific layer in the graph.

When transitioning to tf.keras, the same tensorboard usages were enabled by creating custom tf.keras.callbacks and model._fit_function.fetches and model._fit_function.fetch_callbacks. As described by TensorFlow, the new mechanism does have some advantages and for many (straight forward) usages, it simplifies the logging procedure, requiring just one step instead of two. However, it is not always clear how to implement more advanced usages. Thus, the Amazon Sagemaker Debugger (https://sagemaker.readthedocs.io/en/stable/amazon_sagemaker_debugger.html) (smdebug) package may be useful for this purpose. Amazon smdebug is a python library for tracing and debugging DNN training. It supports a number of frameworks, including TensorFlow (1 and 2). It provides two main functionalities, a tf.keras.callback for capturing and storing selected tensors, and a set of rules for detecting and acting on anomalies that can occur during training. Some of the primary points of relevance for the example developmental flow described herein include the following:

1. The library can be installed (https://pypi.org/project/smdebug/) independent of Sagemaker. The rule functionality can only be applied in the Sagemaker environment, but the debugging hook can run anywhere.

2. The way to use the debugging hook is by defining a set of collections of tensors to be tracked, and passing them to the hook constructor. The hook will capture these tensors, according to the frequency chosen, and store them to a pre-configured location. Additionally, it includes the option to log summaries related to the chosen tensors to TensorBoard.

3. There are also a number of advantages to the debugging capabilities enabled by smdebug over TensorBoard. One is that smdebug enables the capture of full tensors (as opposed to just scalars, histograms, images, etc.).

4. Additionally, smdebug enables free access to the captured data. As opposed to TensorFlow, it can be decided after the fact how to display the data. For example, if one wants to calculate the average of a metric over a fixed window of time, one would need to somehow extract the metric data from the tensor flow event files.

Optimizing Training Time

The motivation for optimizing training time is rather obvious. There are constant pressures to reduce overall development time and be the first to market. Moreover, the motivation to optimize (maximize) utilization of training resources should also be obvious. The goal should be maximizing utilization of all of the resources, but most importantly the GPUs which are the most expensive resource. GPUs cost a lot of money, and letting them sit idle, even partially idle, is wasteful.

It is also critical to have the tools for in-depth analysis of the training pipeline. These tools should be built around basic tools for measuring resource utilization (e.g. nvidia-smi or the Sagemaker instance metrics) and tf profiler (https://www.tensorflow.org/guide/profiler), for profiling your model. There are also many techniques for improving performance (e.g. mixed precision (https://www.tensorflow.org/guide/keras/mixed_precision)). The techniques implemented should be dictated by the profiling data.

Still further, a way to optimize training time is to perform distributed training. However, once again, in depth profiling should be a prerequisite for doing so. In some cases, developers might rush to distribute their training to 8 GPUs, only to learn later that they are actually only using the equivalent computing power of 1 GPU. They very well might have been able to train just as effectively, and for an eighth of the cost, on a single GPU by making some simple changes to their training flow.

What is claimed is:

1. A machine learning model training system, comprising:
one or more processors; and
a memory configured to store instructions that, when executed by the one or more processors, cause the one or more processors to:
receive labeled training data from a data storage;
preprocess the labeled training data to generate training loop data; and
perform, via a machine learning training loop, training and evaluation of the training loop data in accordance with a defined model loss function to generate a machine learning trained model that enables machine vision to recognize and classify objects included in a road scene,
wherein the model loss function receives a plurality of tensors associated with a set of labels of the labeled training data and provides model loss function outputs,
wherein the machine learning training loop (i) flattens and concatenates the set of labels to generate a combined input tensor, and (ii) flattens and concatenates the model loss function outputs to generate a combined output tensor, and
wherein the model loss function uses the combined input tensor and the combined output tensor to generate the machine learning trained model.

2. The machine learning model training system, of claim 1, wherein the one or more processors are configured to preprocess the labeled training data by combining the set of labels of the labeled training data into a single label.

3. The machine learning model training system of claim 2, wherein the single label of the combined set of labels of the labeled training data have the same name as the combined output tensor.

4. The machine learning model training system of claim 1, wherein the one or more processors are configured, when executing the instructions stored in the memory, to perform an additional preprocessing using the model loss function to split the combined input tensors and the combined output tensor tensors back into respective individual tensors.

5. The machine learning model training system of claim 1, wherein the model loss function is represented as a graph having a plurality of layers that include a tf.keras.layers.flatten layer and a tf.keras.layers concatenate layer.

6. The machine learning model training system of claim 1, wherein the model loss function compromises a TensorFlow Keras loss function.

7. A machine learning model training system, comprising:
one or more processors; and
a memory configured to store instructions that, when executed by the one or more processors, cause the one or more processors to:
receive labeled training data from a data storage storing a training dataset;
preprocess the labeled training data to generate training loop data; and
perform, via a machine learning training loop, training and evaluation of the training loop data in accordance with a model loss function to generate a machine learning trained model that enables machine vision to recognize and classify objects included in a road scene,
wherein the machine learning trained model includes a plurality of layers, the plurality of layers including a loss calculation layer configured to perform a loss calculation in accordance with the model loss function such that the machine learning trained model outputs a result of the loss calculation.

8. The machine learning model training system of claim 7, wherein the result of the loss calculation are provided by the loss calculation layer as scalar values.

9. The machine learning model training system of claim 7, wherein labeled training data includes a dummy loss target for the model loss function.

10. The machine learning model training system of claim 7, wherein the one or more processors are configured to, when executing the instructions stored in the memory:
store each one of a plurality of labels used by the machine learning trained model in the data storage as graph input features; and
relocate each one of the plurality of labels to a dictionary of features in the dataset stored in the data storage.

11. The machine learning model training system of claim 7, wherein the model loss function comprises a TensorFlow Keras loss function.

12. A machine learning model training system, comprising:
one or more processors; and
a memory configured to store instructions that, when executed by the one or more processors, cause the one or more processors to:
receive labeled training data from a data storage;
preprocess the labeled training data to generate training loop data; and
execute a plurality of training steps as part of a machine learning training loop that utilizes the training loop data to generate a machine learning trained model that enables machine vision to recognize and classify objects included in a road scene,
wherein the machine learning training loop uses an iteratively-executed training function that stores, at each one of the plurality of training steps, data features and labels used by the machine learning trained model, and
wherein the iteratively-executed training function is configured, in response to detecting an error corresponding to model gradients being invalid at a respective one of the plurality of training steps, to stop execution of the machine learning training loop and to store, in the data storage, the data features, labels, and a state of the machine learning trained model corresponding to a respective one of the plurality of training steps at which the error was detected.

13. The machine learning model training system of claim 12, wherein the iteratively-executed training function is configured to detect the error by comparing the model gradients at each respective one of the plurality of training steps to a predetermined value.

14. The machine learning model training system of claim 13, wherein the model gradients comprise gradient values, and
wherein the iteratively-executed training function is configured to compare the gradient values at each respective one of the plurality of training steps to the predetermined value prior to applying the gradient values to model weights used in accordance with the machine learning training loop.

15. The machine learning model training system of claim 14, wherein the predetermined value is identified with a Not a Number (NaN) value.

16. The machine learning model training system of claim 12, wherein the state of the machine learning trained model stored in the data storage comprises model weights corresponding to a respective one of the plurality of training steps at which the invalid the model gradients were detected.

17. The machine learning model training system of claim 12, wherein the iteratively-executed training function comprises a tf.keras.models.Model object used in accordance with Tensorflow.

18. The machine learning model training system of claim 17, wherein the tf.keras.models.Model object comprises a class that defines a Boolean flag to signal to the iteratively-executed training function whether the error was detected.

19. A machine learning model training system, comprising:
one or more processors; and
a memory configured to store instructions that, when executed by the one or more processors, cause the one or more processors to:
receive labeled training data from a data storage;
preprocess the labeled training data to generate training loop data; and
execute a machine learning training loop that utilizes the training loop data to generate a machine learning trained model that enables machine vision to recognize and classify objects included in a road scene,
wherein the machine learning trained model comprises a plurality of layers, the plurality of layers including a capture layer interleaved between a first layer and a second layer of the plurality of layers and configured to capture intermediate tensors that are output by the first layer and input to the second layer, and
wherein the capture layer causes the one or more processors to store the intermediate tensors in the data storage.

20. The machine learning model training system of claim 19, wherein the intermediate tensors are multi-dimensional arrays of a uniform type.

21. The machine learning model training system of claim 19, wherein the capture layer is configured to cause the one or more processors to store the intermediate tensors as an internal non-trainable weight variable.

22. The machine learning model training system of claim 19, wherein the machine learning training loop utilizes the training loop data to generate the machine learning trained model in accordance with a model loss function, and
wherein the capture layer causes the one or more processors to store, as the intermediate tensors in the data storage, tensors identified with the model loss function.

23. The machine learning model training system of claim 19, wherein the capture layer does not perform calculations in accordance with the machine learning trained model.

24. The machine learning model training system of claim 19, wherein the capture layer comprises a TensorFlow Keras layer.
